(19) United States
(12) Patent Application Publication
(10) Pub. No.: US 2026/0342451 A1
(43) Pub. Date: Oct. 29, 2026

(54) SIGNAL PROCESSING METHOD AND SYSTEM FOR OPTICAL COMMUNICATION RECEIVING END

(71) Applicant: InnoLight Technology (Suzhou) Ltd., Suzhou , Jiangsu (CN)

(72) Inventor: Ning Cheng, Suzhou , Jiangsu (CN)

(21) Appl. No.: 19/119,756

(22) PCT Filed: Aug. 24, 2023
(86) PCT No.: PCT/CN2023/114567

§ 371 Date: Apr. 9, 2025

(30) Foreign Application Priority Data
Oct. 25, 2022 (CN) 202211309090.3

(51) Int. Cl. H04B 10/69; H04B 10/67

(52) U.S. Cl. CPC H04B 10/697; H04B 10/67; H04B 10/691

(57) ABSTRACT

The present disclosure relates to a signal processing method and system for an optical communication receiving end. The method comprises: receiving an optical signal and converting the optical signal into an electrical signal; performing high-pass filtering on the electrical signal to obtain a first processed signal; performing filtering processing on the first processed signal by using an adaptive filter, so as to obtain a second processed signal; and acquiring a difference between the electrical signal and the first processed signal, and according to the difference, adjusting the parameter setting of the adaptive filter to change the filtering characteristic of the adaptive filter. The use of the method can effectively filter out noise in a transmitted signal and improve the quality of signal transmission.

### CROSS-REFERENCE TO RELATED PATENT APPLICATION

This application claims priority to a Chinese patent application filed with the Chinese Patent Office on Oct. 25, 2022, with application number 202211309090.3 and invention name “Signal processing method and system for optical communication receiving end”, the entire contents of which are incorporated by reference in this application.

### FIELD OF THE DISCLOSURE

The present disclosure relates to the technical field of data transmission, and in particular to a signal processing method and system for an optical communication receiving end.

### BACKGROUND TECHNIQUE

As data center transmission rates continue to increase, pulse amplitude modulation has been widely used in short-distance optical interconnection and optical transmission systems. However, in actual transmission systems, the optical transmitter, optical receiver, and optical fiber connector will cause reflections. When the optical signal passes through multiple reflective end faces during transmission, it will cause multipath interference effects. Pulse amplitude modulation signals are more susceptible to multipath interference effects.

In order to reduce the impact of MPI, the return loss of the connectors in the optical module and the optical fiber link can be strictly limited. However, in the actual optical fiber links that have been deployed, there are many connectors and the return loss of the connectors is difficult to control below the ideal value. The noise generated by the multipath interference effect will bring a large optical power cost to the signal transmission.

### SUMMARY OF THE DISCLOSURE

According to this, it is necessary to provide a signal processing method and system for an optical communication receiving end that can effectively filter out the impact of noise and improve signal transmission quality in response to the above technical problems.

In a first aspect, an embodiment of the present disclosure provides a signal processing method at an optical communication receiving end. The method comprises:
receiving an optical signal and converting the optical signal into an electrical signal;
performing high-pass filtering on the electrical signal to obtain a first processed signal;
performing filtering processing on the first processed signal by using an adaptive filter, so as to obtain a second processed signal; and
acquiring a difference between the electrical signal and the first processed signal, and adjusting a parameter setting of the adaptive filter according to the difference to change a filtering characteristic of the adaptive filter.

In one embodiment, obtaining a difference between the electrical signal and the first processed signal, and adjusting a parameter setting of the adaptive filter according to the difference to change a filtering characteristic of the adaptive filter comprises:
acquiring a difference between the electrical signal and the first processed signal; and
adjusting the parameter setting of the adaptive filter according to the difference to change the filtering characteristics of the adaptive filter to obtain an adjusted adaptive filter, wherein the adjusted adaptive filter is configured to perform filtering processing on the next first processing signal.

In one embodiment, adjusting the parameter setting of the adaptive filter according to the difference to change the filtering characteristics of the adaptive filter comprises:
determining a target parameter that matches the difference according to a correlation relationship between the difference and the parameters of the adaptive filter; and
adjusting the parameter settings of the adaptive filter according to the target parameters to change the filtering characteristics of the adaptive filter.

In one embodiment, determining a target parameter that matches the difference according to a correlation relationship between the difference and the parameters of the adaptive filter comprises:
acquiring a third processed signal, wherein the third processed signal is obtained by filtering the electrical signal using a low-pass filter, and the third processed signal is positively correlated with the received optical power;
determining a normalized processed signal matching the electrical signal according to the difference and the third processed signal; and
determining a target parameter matching the normalized processed signal according to a correlation relationship between the normalized processed signal and the parameters of the adaptive filter.

In one embodiment, the adaptive filter comprises a digital adaptive filter, and performing filtering processing on the first processed signal by using an adaptive filter, so as to obtain a second processed signal comprises:
performing analog-to-digital conversion on the first processed signal to obtain a first digital processed signal; and
performing filtering processing on the first digital processed signal by using an adaptive filter, so as to obtain a second processed signal.

In one embodiment, the optical signal is obtained by performing DC balanced encoding and modulation on the original optical signal.

In one embodiment, after obtaining the second processed signal further comprises:
performing signal recovery processing on the second processed signal, so as to obtain a recovered signal.

In one embodiment, the receiving an optical signal and converting the optical signal into an electrical signal comprises:
acquiring an optical signal sent by a signal source; and
performing photoelectric conversion on the optical signal to obtain a converted signal, and amplifying the converted signal to obtain an electrical signal.

In one embodiment, the parameters of the adaptive filter comprise a number of taps, and adjusting a parameter setting of the adaptive filter according to the difference to change a filtering characteristic of the adaptive filter comprises:
determining a target number of taps corresponding to the difference value according to a correlation relationship between the difference value and the number of taps of the adaptive filter; and
adjusting the number of taps of the adaptive filter according to the target number of taps to change the filtering characteristics of the adaptive filter.

In a second aspect, the present disclosure also provides a signal processing device at an optical communication receiving end. The device comprises:
a receiving module, configured to receive an optical signal and converting the optical signal into an electrical signal;
a first filtering module, configured to perform high-pass filtering on the electrical signal to obtain a first processed signal;
a second filtering module, configured to filter the first processed signal by using an adaptive filter to obtain a second processed signal; and
an adjustment module, configured to obtain the difference between the electrical signal and the first processed signal, and adjust the parameter setting of the adaptive filter according to the difference to change the filtering characteristics of the adaptive filter.

In one embodiment, the adjustment module comprises:
an acquisition module, configured to acquire a difference between the electrical signal and the first processed signal;
a first adjustment submodule, configured to adjust the parameter settings of the adaptive filter according to the difference to change the filtering characteristics of the adaptive filter to obtain an adjusted adaptive filter, wherein the adjusted adaptive filter is configured to filter the next first processed signal.

In one embodiment, the first adjustment submodule comprises:
a first determination module, configured to determine a target parameter matching the difference value according to a correlation relationship between the difference value and a parameter of an adaptive filter; and
an adjustment unit, configured to adjust the parameter setting of the adaptive filter according to the target parameter to change the filtering characteristics of the adaptive filter.

In one embodiment, the adjustment unit comprises:
an acquisition module, configured to acquire a third processed signal, wherein the third processed signal is obtained by filtering the electrical signal using a low-pass filter, and the third processed signal is positively correlated with the received optical power;
a second determination module, configured to determine a normalized processed signal matching the electrical signal according to the difference and the third processed signal; and
the third determination module, configured to determine the target parameter matching the normalized processed signal according to a correlation relationship between the normalized processed signal and the parameters of the adaptive filter.

In one embodiment, the adaptive filter comprises a digital adaptive filter, and the second filtering module comprises:
a conversion module, configured to perform analog-to-digital conversion on the first processed signal to obtain a first digital processed signal; and
a filtering submodule, configured to filter the first digital processing signal by using the adjusted adaptive filter to obtain a second processing signal.

In one embodiment, the optical signal is obtained by performing DC balanced encoding and modulation on the original optical signal.

In one embodiment, the second filtering module further comprises:
a recovery module, configured to perform signal recovery processing on the second processed signal to obtain a recovered signal.

In one embodiment, the receiving module comprises:
an acquisition submodule, configured to acquire an optical signal sent by a signal source;
an amplification module, configured to perform photoelectric conversion on the optical signal to obtain a converted signal and amplify the converted signal to obtain an electrical signal.

In one embodiment, the parameters of the adaptive filter comprise the number of taps, and the adjustment module comprises:
a fourth determination module, configured to determine a target number of taps corresponding to the difference value according to a correlation relationship between the difference value and the number of taps of the adaptive filter; and
a second adjustment submodule, configured to adjust the number of taps of the adaptive filter according to the target number of taps to change the filtering characteristics of the adaptive filter.

In a third aspect, an embodiment of the present disclosure further provides a signal processing system for an optical communication receiving end, the system comprising:
a photodetector, configured to receive an optical signal and converting the optical signal into an electrical signal;
a high-pass filter, configured to perform high-pass filtering on the electrical signal to obtain a first processed signal; and
an adaptive filter, configured to filter the first processed signal to obtain a second processed signal, wherein the parameters of the adaptive filter are adjusted according to the difference between the electrical signal received by the photodetector and the corresponding first processed signal.

In one embodiment, the adaptive filter comprises:
an adaptive filter, configured to filter the first processed signal to obtain a second processed signal, wherein the parameters of the adaptive filter are adjusted according to the difference between the previous electrical signal and the corresponding first processed signal.

In one embodiment, the system further comprises:
an analog-to-digital converter, configured to perform analog-to-digital conversion on the first processed signal to obtain a first digital processed signal; and
the adaptive filter comprising:
a digital adaptive filter, configured to filter the first digital processed signal to obtain a second processed signal, wherein the parameters of the adaptive filter are adjusted according to the difference between the electrical signal received by the photodetector and the corresponding first processed signal.

In one embodiment, the system further comprises:
a decoder, configured to decode the second processed signal to obtain a restored signal.

In a fourth aspect, an embodiment of the present disclosure further provides a computer device. The computer device comprises a memory and a processor, the memory stores a computer program, and the processor implements the steps of any one of the methods in the embodiments of the present disclosure when executing the computer program.

In a fifth aspect, the embodiments of the present disclosure further provide a computer-readable storage medium, wherein a computer program is stored thereon, and when the computer program is executed by a processor, the steps of any one of the methods in the embodiments of the present disclosure are implemented.

In a sixth aspect, the embodiments of the present disclosure further provide a computer program product, wherein the computer program product comprises a computer program, and when the computer program is executed by a processor, the steps of any one of the methods in the embodiments of the present disclosure are implemented.

In the disclosed embodiment, the received optical signal is converted into an electrical signal, a first processed signal is obtained after the electrical signal is filtered by a high-pass filter, and the parameters of the adaptive filter are adjusted according to the difference between the electrical signal and the first processed signal to change the filtering characteristics of the filter, and the adjusted adaptive filter is obtained. The first processed signal is processed by the adaptive filter to obtain the second processed signal, and the parameters of the adaptive filter are dynamically adjusted according to the received electrical signal. The signal processing method of this embodiment adjusts the parameters of the filter according to the different signals received by the optical detector, which is applicable to more scenarios, improves the accuracy of noise filtering, reduces the optical power cost of signal transmission, and ensures the quality of signal transmission. By filtering the noise through the adaptive filter, it can be adjusted in real time according to different noises in different signals and different scenarios, so that the noise can be better suppressed, and the inter-symbol interference caused by fiber dispersion or insufficient receiver bandwidth can be dynamically compensated, so that the bit error rate of the receiver is minimized. After the received electrical signal is processed by high-pass filtering, part of the noise can be filtered out, which can make the adaptive filter converge faster and the error after convergence smaller; after high-pass filtering, adaptive filtering is performed to reduce the complexity of the adaptive filter.

### BRIEF DESCRIPTION OF THE DRAWINGS

FIG. 1 is a diagram showing an application environment of a signal processing method at an optical communication receiving end in one embodiment;

FIG. 2 is a schematic flow chart of a signal processing method at an optical communication receiving end in one embodiment;

FIG. 3 is a schematic flow chart of a signal processing method at an optical communication receiving end in one embodiment;

FIG. 4 is a schematic diagram of the structure of a signal processing system at an optical communication receiving end in one embodiment;

FIG. 5 is a bit error rate curve diagram of signal transmission in one embodiment;

FIG. 6 is a block diagram of a signal processing device at an optical communication receiving end in one embodiment; and

FIG. 7 is a diagram showing the internal structure of a computer device in one embodiment.

### DETAILED DESCRIPTION OF THE EXEMPLARY EMBODIMENTS

In order to make the purpose, technical solution and advantages of the embodiments of the present disclosure more clear, the embodiments of the present disclosure are further described in detail below in conjunction with the accompanying drawings and embodiments. It should be understood that the specific embodiments described herein are only configured to explain the embodiments of the present disclosure and are not configured to limit the embodiments of the present disclosure.

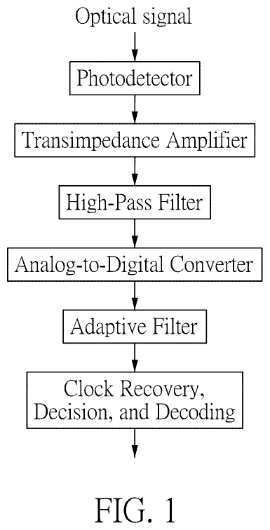

The signal processing method of the optical communication receiving end provided by the embodiment of the present disclosure can be applied in the application environment as shown in FIG. 1.

Referring to FIG. 1, after the optical signal passes through the optical detector, it is converted into a current, and then converted into a voltage signal and amplified by a transimpedance amplifier. The amplified signal is filtered out by a high-pass filter to remove some noise, and converted into a digital signal by an analog-to-digital converter. It is further adaptively filtered by an adaptive filter, and the filtered signal is clock recovered, determined and decoded to obtain a recovered signal, thus realizing signal transmission.

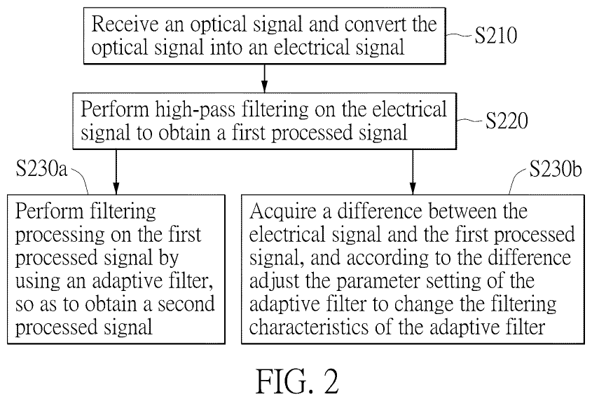

In an embodiment of the present disclosure, as shown in FIG. 2, a signal processing method at an optical communication receiving end is provided, the method comprising the following steps:

Step S210, receiving an optical signal and converting the optical signal into an electrical signal;

During the signal transmission process, the optical communication receiving end receives the optical signal and performs photoelectric conversion on the optical signal to obtain the converted electrical signal, wherein the optical signal can be converted into the electrical signal by a photodetector. The method described in this embodiment can be applied to an optical receiver.

In other embodiments, in step S210, the optical signal is obtained by performing DC balance encoding and modulation on the original optical signal.

Specifically, the signal source performs DC balanced encoding on the original optical signal to obtain an encoded original optical signal. The encoding methods of DC balanced encoding comprise, but are not limited to, 8B10B encoding, MB810 encoding, 5S/6S encoding, and 27S/32S encoding. The encoded signal is modulated to obtain a modulated optical signal, and the modulated optical signal is sent to a receiver, and an optoelectronic conversion process is performed to obtain an electrical signal.

In this embodiment, the original optical signal is DC balanced coded and modulated and then sent to the optical communication receiving end, so that the energy of the transmitted optical signal in the low frequency band near the zero frequency is very low, thereby improving the initial filtering effect of the high-pass filter on the noise; thereby, the difference between the electrical signal obtained by subsequent conversion and the first processed signal can more accurately reflect the noise in the received signal, such as MPI noise, thereby improving the accuracy of the target filtering frequency response and further improving the noise filtering effect of the adjusted adaptive filter.

In other embodiments, in step S210, receiving the optical signal and converting the optical signal into an electrical signal comprises:
acquiring an optical signal sent by a signal source.

Photoelectric conversion is performed on the optical signal to obtain a converted signal, and the converted signal is amplified to obtain an electrical signal.

Specifically, the signal processing method of the optical communication receiving end in this embodiment can be applied to the application scenario of optical signal transmission. The signal sent by the signal source is an optical signal. The optical signal is processed by a photoelectric conversion unit to obtain a converted signal, and the converted signal is amplified by an amplifier to obtain an electrical signal. In one example, a photodetector is used for photoelectric conversion, and a transimpedance amplifier is configured to amplify the converted signal. Specifically, a photodetector can be configured to convert an optical signal into a current signal, and the current signal is converted into a voltage signal and amplified by a transimpedance amplifier. In this embodiment, after obtaining the second processed signal, the second processed signal can be subjected to signal recovery processing, wherein the signal recovery processing comprises converting the electrical signal into an optical signal.

This embodiment realizes application in optical signal transmission scenarios by performing photoelectric conversion and amplification on the optical signal sent by the signal source. In scenarios such as optical fiber communication, the method of this embodiment can be configured to process the transmitted signal to ensure the quality of signal transmission and reduce the noise of the signal after transmission. Through photoelectric conversion and amplification, the effect of subsequent high-pass filtering and the accuracy of filtering frequency response adjustment are improved, thereby ensuring the filtering effect of the adaptive filter, reducing the noise content of the processed signal, and realizing effective transmission of the signal.

Step S220, performing high-pass filtering on the electrical signal to obtain a first processed signal.

The electrical signal is subjected to high-pass filtering to obtain a processed first processed signal, wherein the high-pass filtering is implemented by a high-pass filter. The high-pass filter corresponds to a preset cutoff frequency, and the first processed signal comprises a signal whose frequency is higher than the preset cutoff frequency obtained by high-pass filtering the electrical signal. The preset cutoff frequency of the high-pass filter can be adjusted according to the actual application scenario, for example, it can be set to 20 MHz. In some possible implementations, the types of high-pass filters may comprise, but are not limited to, digital high-pass filters and analog high-pass filters, wherein the types of analog high-pass filters may comprise, but are not limited to, resistor-capacitor filters (RC filters), 4th-order Bessel filters, etc., and is not limited by the present disclosure.

Step S230a, performing filtering processing on the first processed signal by using an adaptive filter, so as to obtain a second processed signal.

After obtaining the first processed signal, the first processed signal is transmitted to an adaptive filter, and filtered through the adaptive filter to obtain a processed second processed signal, wherein the adaptive filter refers to a filter that uses an adaptive algorithm to change the parameters and structure of the filter according to changes in the environment. Among them, the types of filtering processing may comprise high-pass filtering, band-pass filtering, etc., and is not limited by the present disclosure. The adaptive filter will dynamically adjust the frequency response according to the received first processed signal, and different first processed signals may correspond to different frequency responses. Among them, the method for the adaptive filter to adjust the frequency response may comprise but is not limited to the LMS (minimum mean square error, least-mean square) algorithm or the RLS (recursive least square) algorithm, and is not limited by the present disclosure. In this embodiment, the signal noise removed by filtering may comprise but is not limited to MPI noise.

In other embodiments, in step S230a, the adaptive filter comprises a digital adaptive filter, and the step of filtering the first processed signal by using the adaptive filter to obtain the second processed signal comprises:
performing analog-to-digital conversion on the first processed signal to obtain a first digital processed signal.

The first digital processing signal is filtered by using an adaptive filter to obtain a second processing signal.

Specifically, when the adaptive filter is configured to filter, the first processed signal is subjected to analog-to-digital conversion, and the first processed signal is converted from an analog signal to a digital signal to obtain a first digital processed signal. The first digital processed signal is filtered using an adaptive filter to obtain a second processed signal, wherein in this embodiment, the adaptive filter is a digital adaptive filter.

In this embodiment, a first processed signal after analog-to-digital conversion is filtered by a digital adaptive filter to obtain a second processed signal. Compared with the analog adaptive filter, the digital adaptive filter can ensure the noise filtering effect while reducing the structural complexity of the adaptive filter, and make the signal processing method of the optical communication receiving end of this embodiment applicable to more scenarios.

In other embodiments, in step S230a, after the step of obtaining the second processed signal, the step further comprises:
performing signal recovery processing on the second processed signal to obtain a recovered signal.

Specifically, a second processed signal is obtained, and a signal recovery process is performed on the second processed signal to obtain a recovered signal. In one example, the signal recovery process comprises clock recovery, decision, and signal decoding, wherein clock recovery refers to a method of re-obtaining a clock component from a transmitted signal. After clock recovery, decision, and signal decoding, the transmitted signal can be recovered.

After obtaining the second processed signal, this embodiment performs recovery processing on the second processed signal to obtain a recovered signal, thereby realizing signal transmission. By performing signal recovery on the second processed signal after high-pass filtering and adaptive filtering, a signal from which noise has been filtered out can be obtained, thereby ensuring the quality of signal transmission.

Step S230b: acquiring a difference between the electrical signal and the first processed signal, and adjusting parameter settings of the adaptive filter according to the difference to change filtering characteristics of the adaptive filter.

After obtaining the first processed signal, the difference between the electrical signal and the first processed signal is also determined, and the parameter setting of the adaptive filter is adjusted according to the difference, thereby changing the filtering characteristics of the adaptive filter. Since there is a corresponding relationship between the parameters of the adaptive filter and the filtering characteristics, the filtering characteristics will change accordingly when the parameters are adjusted, and the filtering characteristics will affect the filtering effect of the filter, wherein the filtering characteristics comprise the frequency response of the filter. Among them, since the first processed signal is obtained by high-pass filtering the electrical signal, the difference between the electrical signal and the first processed signal can be determined, and there is a positive correlation relationship between the difference and the noise in the optical signal received by the optical communication receiving end. It can be understood that the purpose of the adaptive filter is to filter out noise. Since there is a corresponding relationship between the noise and the difference, the parameters of the adaptive filter can be adjusted according to the difference.

In the embodiments of the present disclosure, the types of adaptive filters may comprise digital adaptive filters, analog adaptive filters, and may also comprise adaptive filters with expected signal inputs, blind equalization adaptive filters with only one input signal, etc., wherein the digital adaptive filter may comprise linear adaptive filters, such as FIR (finite impulse response) filters, IIR (infinite impulse response) filters, and may also comprise nonlinear filters, such as DFE (Decision-Feedback Equalizer), which is not limited in the present disclosure.

It is understandable that step S230a and step S230b can be executed simultaneously or in a preset order. For example, by adding a signal delay device before the adaptive filter, step S230b can be executed first and then step S230a, that is, the parameters are adjusted first, and after the adjustment is completed, the adjusted adaptive filter is configured to filter the first processed signal. The present disclosure is not limited thereto. In actual application scenarios, when the filtering process and the parameter adjustment process are performed simultaneously, the adaptive filter in step S230a may comprise the adaptive filter before the adjustment of step S230b, and may comprise the adaptive filter after the adjustment of step S230b. In the embodiment of the present disclosure, the filtering process and the parameter adjustment of the adaptive filter can be set as a continuous dynamic process, that is, during the signal transmission process, the adaptive filter performs filtering while adjusting the parameters according to the acquired first signal until the signal transmission is completed.

In other embodiments, in step S230b, obtaining a difference between the electrical signal and the first processed signal, and adjusting parameter settings of the adaptive filter according to the difference to change filtering characteristics of the adaptive filter comprise:
acquiring a difference between the electrical signal and the first processed signal.

The parameter setting of the adaptive filter is adjusted according to the difference to change the filtering characteristics of the adaptive filter to obtain an adjusted adaptive filter, wherein the adjusted adaptive filter is configured to perform filtering processing on the next first processing signal.

Specifically, when adjusting the parameter setting of the adaptive filter, the difference between the electrical signal and the first processed signal is determined, and the parameter setting of the adaptive filter is adjusted according to the difference. There is a correlation relationship between the parameter setting of the adaptive filter and the filtering characteristics. Therefore, when the parameters of the adaptive filter change, the filtering characteristics of the adaptive filter also change accordingly. After adjusting the parameters, the adjusted adaptive filter is obtained, and the next first processed signal is filtered using the adjusted adaptive filter, wherein the next first processed signal may comprise the first processed signal corresponding to the next optical signal received, and may also comprise the subsequent processed signal output by the high-pass filter after the current first processed signal. It can be understood that in this embodiment, the process of signal transmission is continuous, the parameter adjustment of the adaptive filter is dynamic adjustment, which is a continuous process, the filtering process of the adaptive filter is also a continuous process, and the speed of signal transmission is greater than the adjustment speed of the adaptive filter, so that after the parameters of the adaptive filter are adjusted, it is configured to filter the subsequent first processed signal. Due to the continuity between the signals, filtering can be performed while dynamically adjusting the parameters of the adaptive filter, which can achieve a better filtering effect while ensuring the filtering efficiency.

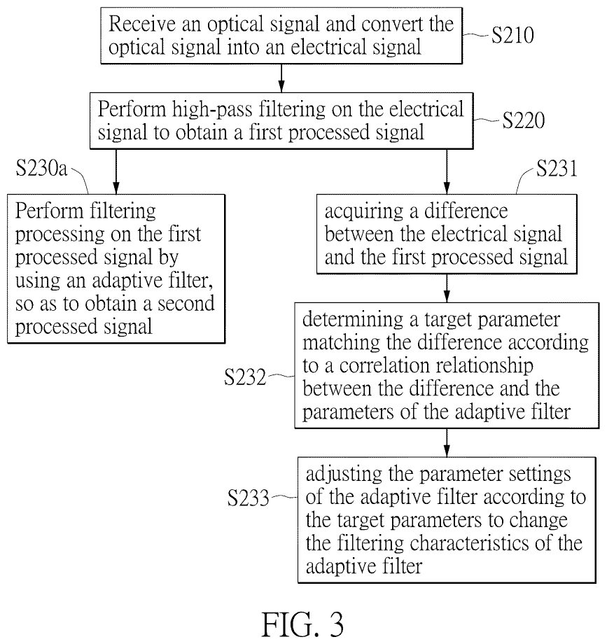

In other embodiments, as shown in FIG. 3, in step S230b, adjusting the parameter setting of the adaptive filter according to the difference to change the filtering characteristics of the adaptive filter comprises:
Step S232, determining a target parameter matching the difference according to a correlation relationship between the difference and the parameters of the adaptive filter; and
Step S233: adjusting the parameter settings of the adaptive filter according to the target parameters to change the filtering characteristics of the adaptive filter.

Specifically, the function of the adaptive filter is to filter out noise, and there is a correlation relationship between the difference and the noise, so a correlation relationship between the difference and the parameters of the adaptive filter can be determined. According to a correlation relationship between the difference and the parameters of the adaptive filter, the target parameter corresponding to the difference can be determined. According to the target parameter, the adaptive filter is adjusted. It can be understood that in this embodiment, the filtering characteristics of the adjusted adaptive filter enable the adaptive filter to have a better filtering effect on the noise in the corresponding electrical signal. Usually, different differences correspond to different parameters of the adaptive filter, and a correlation relationship between the difference and the parameters of the adaptive filter can be determined in advance according to the actual application scenario. Among them, the parameters of the filter comprise filtering parameters that can affect the filtering effect of the filter, and the filtering effects of the adaptive filter corresponding to different filtering parameters are usually different. The parameters of the filter may comprise, but are not limited to, parameters such as the number of taps, tap coefficients, and step factors. In some possible implementations, the parameters of the filter are set to the number of taps, and a correlation relationship between the parameters of the filter and the difference may comprise a positive correlation, that is, the larger the difference, the more the number of taps, wherein the difference is the difference between the electrical signal and the first processed signal. When setting a correlation relationship between the difference and the noise, the difference is the difference between the electrical signal and the first processed signal. A preset coefficient can be set according to the actual application scenario and the relationship between the difference and the noise. After determining the difference, the target parameter is directly obtained according to the difference and the preset coefficient. For example, if the filter parameter is the number of taps, the preset coefficient can be determined according to the order of the high-pass filter and the cutoff frequency.

This embodiment obtains the difference between the electrical signal and the first processed signal, determines the target parameters according to a correlation relationship between the difference and the filter parameters, adjusts the parameters of the adaptive filter to the target parameters, so that the filtering characteristics of the adjusted adaptive filter meet the requirements, and adjusts the filtering characteristics of the adaptive filter according to the change of the electrical signal, so that the adjusted adaptive filter can effectively filter out the noise in the electrical signal, and has high flexibility and can be applied to various scenarios. The target parameters are determined according to the relationship between the difference and the parameters, and the adjustment method is simple and accurate, which further ensures the effectiveness of noise filtering.

In other embodiments, in step S232, determining a target parameter matching the difference according to a correlation relationship between the difference and the parameter of the adaptive filter comprises:

acquiring a third processed signal, wherein the third processed signal is obtained by filtering the electrical signal using a low-pass filter, and the third processed signal is positively correlated with the received optical power;

determining a normalized processed signal matching the electrical signal according to the difference and the third processed signal; and determining a target parameter matching the normalized processed signal according to a correlation relationship between the normalized processed signal and the parameters of the adaptive filter.

Specifically, when determining the target parameter, a high-pass filter is configured to perform high-pass filtering on the electrical signal to obtain a first processing signal, and the difference between the electrical signal and the first processing signal is determined. It can be considered that there is a positive correlation relationship between the difference and the noise in the electrical signal. The electrical signal is low-pass filtered using a low-pass filter to obtain a third processing signal, and the third processing signal has a positive correlation with the received optical power, wherein the received optical power can be determined according to the third processing signal. A normalized processing signal is determined according to the difference and the third processing signal, wherein there is a correlation relationship between the normalized processing signal and the noise of the electrical signal. In other possible implementations, the normalized processing signal can be determined according to the ratio of the difference to the third processing signal. In other possible implementations, a first coefficient can be set according to a correlation relationship between the difference and the noise, a second coefficient can be determined according to a correlation relationship between the third processing signal and the received optical power, a noise signal can be determined using the difference and the first coefficient, a received optical signal can be determined using the third processing signal and the second coefficient, and a normalized processing signal can be determined according to the ratio between the noise signal and the received optical signal. It is understandable that after determining the difference and the third processed signal, other possible implementation methods can also be configured to obtain a normalized processed signal, and the present disclosure is not limited thereto. Among them, the normalized processed signal may comprise, but is not limited to, normalized noise power, a signal having a corresponding relationship with the noise power, etc. According to a correlation relationship between the normalized processed signal and the parameters of the adaptive filter, the target parameters that match the normalized processed signal are determined. In other possible implementation methods, a correlation relationship between the normalized processed signal and the parameters of the filter can be directly determined according to the actual application scenario, and after determining that the normalized processed signal is obtained, the corresponding target filtering parameters are determined according to the preset correlation relationship.

In this embodiment, a third processed signal is obtained through a low-pass filter, and a normalized processed signal is determined in combination with the difference between the electrical signal and the first processed signal, and then the parameters of the adaptive filter are determined according to the normalized processed signal. Since a correlation relationship between the normalized processed signal and the noise is more accurate, the proportion of noise in the transmitted signal can be better determined through the normalized processed signal. The target parameters are determined according to the normalized processed signal, which can make the adjusted adaptive filter have a better noise filtering effect, further reduce the optical power cost, be suitable for more scenarios, and ensure the quality of signal transmission.

In other embodiments, in step S230b, the parameters of the adaptive filter comprise the number of taps, and adjusting the parameter settings of the adaptive filter according to the difference to change the filtering characteristics of the adaptive filter comprises:
determining a target number of taps corresponding to the difference value according to a correlation relationship between the difference value and the number of taps of the adaptive filter.

The number of taps of the adaptive filter is adjusted according to the target number of taps to change the filtering characteristics of the adaptive filter.

Specifically, the parameters of the adaptive filter comprise the number of taps, and when the parameters of the adaptive filter are set, the number of taps of the filter is adjusted. According to a correlation relationship between the difference and the number of taps, the target number of taps corresponding to the acquired difference is determined. Among them, there is a correlation relationship between the difference between the electrical signal and the first processed signal and the noise, and there is a correlation relationship between the number of taps and the noise filtering effect of the adaptive filter. Therefore, a corresponding relationship between the difference and the number of taps can be established according to the above correlation, and different differences usually correspond to different numbers of taps. The adaptive filter is adjusted according to the target number of taps to obtain an adjusted adaptive filter, wherein there is a corresponding relationship between the frequency characteristics of the adjusted adaptive filter and the electrical signal. It can be understood that the frequency characteristics of the adaptive filter comprise the frequency response of the filter.

This embodiment adjusts the number of taps of the adaptive filter by the difference between the electrical signal and the first processed signal, so that the frequency characteristics of the adjusted adaptive filter meet the requirements while ensuring the rationality of the number of taps of the adaptive filter, avoiding the problem of waste of resources caused by too large a number of taps or the problem of poor filter performance caused by too small a number of taps.

In other embodiments, the parameter settings of the adaptive filter may also be adjusted directly according to the size of the difference until the adjusted filtering characteristics meet the preset conditions, wherein the preset conditions may be set according to the actual application scenario.

In the disclosed embodiment, the received optical signal is converted into an electrical signal, a first processed signal is obtained after the electrical signal is filtered by a high-pass filter, and the parameters of the adaptive filter are adjusted according to the difference between the electrical signal and the first processed signal to change the filtering characteristics of the filter, and the adjusted adaptive filter is obtained. The first processed signal is processed by the adaptive filter to obtain the second processed signal, and the parameters of the adaptive filter are dynamically adjusted according to the received electrical signal. The signal processing method of this embodiment adjusts the parameters of the filter according to the different signals received by the optical detector, which is applicable to more scenarios, improves the accuracy of noise filtering, reduces the optical power cost of signal transmission, and ensures the quality of signal transmission. By filtering the noise through the adaptive filter, it can be adjusted in real time according to different noises in different signals and different scenarios, so that the noise can be better suppressed, and the inter-symbol interference caused by fiber dispersion or insufficient receiver bandwidth can be dynamically compensated, so that the bit error rate of the receiver is minimized. After the received electrical signal is processed by high-pass filtering, part of the noise can be filtered out, which can make the adaptive filter converge faster and the error after convergence smaller; after high-pass filtering, adaptive filtering is performed to reduce the complexity of the adaptive filter.

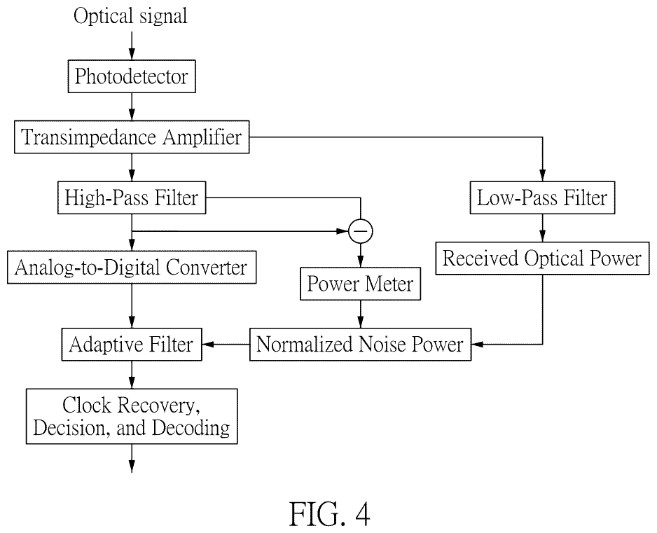

FIG. 4 is a structural diagram of a signal processing system according to an exemplary embodiment. Referring to FIG. 4, an optical signal is converted into a current signal by an optical detector, and then converted into a voltage signal and amplified by a transimpedance amplifier. After the amplified signal is filtered by an analog high-pass filter, it is sent to an analog-to-digital converter to be converted into a digital signal, and filtered by an adaptive filter to obtain a filtered signal. The filtered signal is clock recovered, determined and decoded to obtain a recovered binary code stream, thereby realizing signal transmission. Among them, the adaptive filter corresponds to filtering parameters, including the number of taps and the tap coefficient. If the number of taps is too large, the logic resources of the digital chip will be wasted, resulting in an increase in cost and power consumption, while if the number of taps is too small, the performance of the adaptive filter will be reduced. In this embodiment, during the signal processing process, the number of taps and the tap coefficient of the adaptive filter are dynamically adjusted. In one example, the tap coefficient can be adjusted by training historical data or by blind equalization, which is not limited in the present disclosure. In this embodiment, the number of taps is determined according to the size of the noise of the signal (or according to the spectrum of the noise); since in this embodiment, the difference between the input and output signals of the high-pass filter can approximately reflect the size of the noise (such as MPI noise), the number of taps of the adaptive filter can be determined according to the difference and the preset coefficient. Among them, the preset coefficient is set to be related to the received optical power and the high-pass filter parameters, and the high-pass filter parameters may comprise, but are not limited to, the filter order and the filter cutoff frequency. When determining the received optical power, the amplified signal is low-pass filtered by a low-pass filter, and the voltage value obtained is proportional to the received optical power, and the received optical power is determined according to the obtained voltage value; the amplified signal is high-pass filtered by a high-pass filter, and the power difference is obtained by subtracting the power of the output signal from the power of the input signal, and the power difference is proportional to the noise size, and the noise power is determined by a power meter. Determining the ratio of the noise power to the received optical power is the normalized noise power. The number of taps is determined according to the normalized noise power and the preset value, wherein the preset value is a more appropriate coefficient value determined according to the actual application scenario, and the number of taps can be determined by rounding.

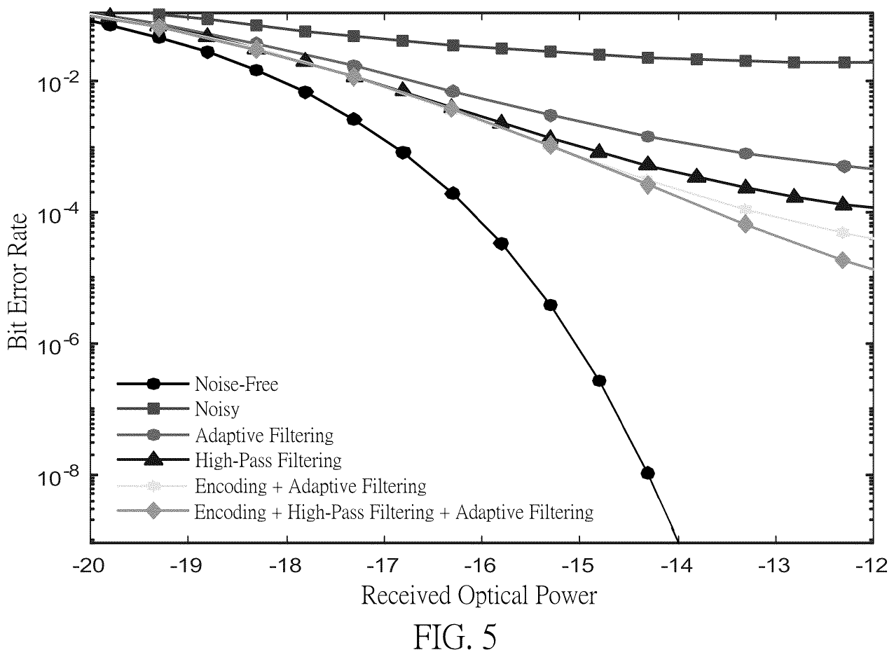

FIG. 5 is a bit error rate curve diagram of signal transmission according to an exemplary embodiment. Referring to FIG. 5, under 25 Gbaud/s PAM4 modulated optical transmission, the bit error rates corresponding to different scenarios are different. In this embodiment, the MPI noise is set to −23 dB. It can be seen that the MPI noise of −23 dB has a great influence on the bit error rate, which is several orders of magnitude lower than the bit error rate without noise. The commonly used forward error correction code KP4 FEC has an error correction threshold of 2.4′10-4. The noisy bit error rate curve shown in the figure cannot reach the error correction threshold of KP4 FEC, that is, when the MPI noise is −23 dB, an ordinary receiver cannot achieve error-free transmission even if KP4 FEC is used. According to the bit error rate curve obtained by the receiver using a high-pass filter in the figure, such as an analog high-pass filter, including but not limited to an ordinary RC filter, it can be seen that after the bandwidth of the high-pass filter is optimized, the bit error rate curve under noise is significantly improved. Compared with ordinary receivers, the bit error rate is reduced by two orders of magnitude at −12 dBm received optical power, but the bit error rate is still large. It can be seen from the curve in the reference figure that after the adaptive filter is adopted, the frequency response of the receiver can be dynamically adjusted according to the size and spectrum of the noise and the bit error rate is lower than that of an ordinary high-pass filter. After combining with DC balanced coding, the bit error rate is further reduced. On the basis of DC balanced coding, a fixed analog filter combined with an adaptive digital filter is configured to achieve a smaller bit error rate.

The disclosed embodiments, by combining DC balanced coding, high-pass filtering and adaptive filtering, can effectively filter out noise, reduce the bit error rate and improve the quality of signal transmission.

It should be understood that, although the steps in the flowchart of the accompanying drawings are displayed in sequence as indicated by the arrows, these steps are not necessarily executed in sequence in the order indicated by the arrows. Unless otherwise specified herein, there is no strict order restriction on the execution of these steps, and these steps can be executed in other orders. Moreover, at least a portion of the steps in the accompanying drawings may comprise multiple steps or multiple stages, and these steps or stages are not necessarily executed at the same time, but can be executed at different times, and the execution order of these steps or stages is not necessarily sequential, but can be executed in turn or alternately with other steps or at least a portion of the steps or stages in other steps.

According to the same inventive concept, the embodiment of the present disclosure also provides a signal processing device for implementing the signal processing method of the optical communication receiving end involved above. The implementation scheme for solving the problem provided by the device is similar to the implementation scheme recorded in the above method, so that the specific limitations in the embodiments of the signal processing device for one or more optical communication receiving ends provided below can refer to the limitations of the signal processing method for the optical communication receiving end above, and will not be repeated here.

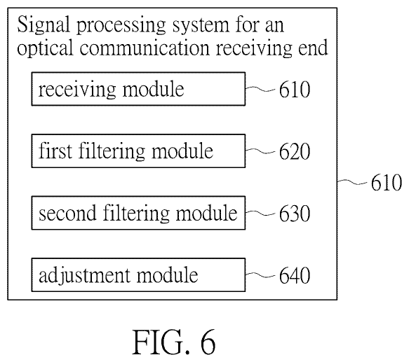

In one embodiment, as shown in FIG. 6, a signal processing device 600 of an optical communication receiving end is provided, comprising:

a receiving module 610, configured to receive the optical signal and convert the optical signal into an electrical signal;
a first filtering module 620, configured to perform high-pass filtering on the electrical signal to obtain a first processed signal;
a second filtering module 630, configured to filter the first processed signal by using an adaptive filter to obtain a second processed signal; and
an adjustment module 640, configured to obtain the difference between the electrical signal and the first processed signal, and adjust the parameter setting of the adaptive filter according to the difference to change the filtering characteristics of the adaptive filter.

In one embodiment, the adjustment module comprises:
an acquisition module, configured to acquire a difference between the electrical signal and the first processed signal; and
a first adjustment submodule, configured to adjust the parameter settings of the adaptive filter according to the difference to change the filtering characteristics of the adaptive filter to obtain an adjusted adaptive filter, wherein the adjusted adaptive filter is configured to filter the next first processed signal.

In one embodiment, the first adjustment submodule comprises:
a first determination module, configured to determine a target parameter matching the difference value according to an association relationship between the difference value and a parameter of an adaptive filter; and
an adjustment unit, configured to adjust the parameter setting of the adaptive filter according to the target parameter to change the filtering characteristics of the adaptive filter.

In one embodiment, the adjustment unit comprises:
an acquisition module, configured to acquire a third processed signal, wherein the third processed signal is obtained by filtering the electrical signal using a low-pass filter, and the third processed signal is positively correlated with the received optical power;
a second determination module, configured to determine a normalized processed signal matching the electrical signal according to the difference and the third processed signal; and
a third determination module, configured to determine the target parameter matching the normalized processed signal according to a correlation relationship between the normalized processed signal and the parameters of the adaptive filter.

In one embodiment, the adaptive filter comprises a digital adaptive filter, and the second filtering module comprises:
a conversion module, configured to perform analog-to-digital conversion on the first processed signal to obtain a first digital processed signal; and
a filtering submodule, configured to filter the first digital processing signal by using the adjusted adaptive filter to obtain a second processing signal.

In one embodiment, the optical signal is obtained by performing DC balance encoding and modulation on the original optical signal.

In one embodiment, the second filtering module further comprises:
a recovery module, configured to perform signal recovery processing on the second processed signal to obtain a recovered signal.

In one embodiment, the receiving module comprises:
an acquisition submodule, configured to acquire an optical signal sent by a signal source; and
an amplification module, configured to perform photoelectric conversion on the optical signal to obtain a converted signal, and amplify the converted signal to obtain an electrical signal.

In one embodiment, the parameters of the adaptive filter comprise the number of taps, and the adjustment module comprises:
a fourth determination module, configured to determine a target number of taps corresponding to the difference value according to a correlation relationship between the difference value and the number of taps of the adaptive filter; and
a second adjustment submodule, configured to adjust the number of taps of the adaptive filter according to the target number of taps to change the filtering characteristics of the adaptive filter.

Each module in the signal processing device of the optical communication receiving end can be implemented in whole or in part by software, hardware and a combination thereof. Each module can be embedded in or independent of a processor in a computer device in the form of hardware, or can be stored in a memory in a computer device in the form of software, so that the processor can call and execute the operations corresponding to each module.

In one embodiment, a signal processing system for an optical communication receiving end is provided, the system comprising:
a photodetector, configured to receive an optical signal and converting the optical signal into an electrical signal;
a high-pass filter, configured to perform high-pass filtering on the electrical signal to obtain a first processed signal; and
an adaptive filter, configured to filter the first processed signal to obtain a second processed signal, wherein the parameters of the adaptive filter are adjusted according to the difference between the electrical signal received by the photodetector and the corresponding first processed signal.

In one embodiment, the adaptive filter comprises:
an adaptive filter, configured to filter the first processed signal to obtain a second processed signal, wherein the parameters of the adaptive filter are adjusted according to the difference between the previous electrical signal and the corresponding first processed signal.

In one embodiment, the system further comprises:
an analog-to-digital converter, configured to perform analog-to-digital conversion on the first processed signal to obtain a first digital processed signal;

the adaptive filter comprising:
a digital adaptive filter, configured to filter the first digital processed signal to obtain a second processed signal, wherein the parameters of the adaptive filter are adjusted according to the difference between the electrical signal received by the photodetector and the corresponding first processed signal.

In one embodiment, the system further comprises:
a decoder, configured to decode the second processed signal to obtain a restored signal.

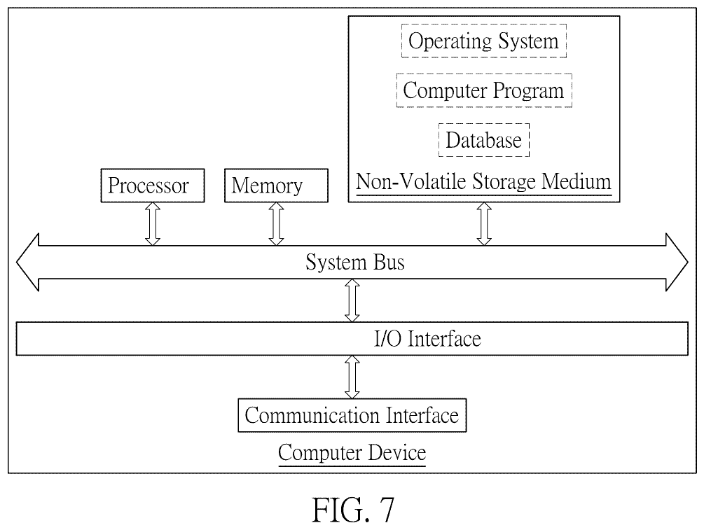

In one embodiment, a computer device is provided, which may be a server, and its internal structure diagram may be shown in FIG. 7. The computer device comprises a processor, a memory, and a network interface connected via a system bus. The processor of the computer device is configured to provide computing and control capabilities. The memory of the computer device comprises a non-volatile storage medium and an internal memory. The non-volatile storage medium stores an operating system, a computer program, and a database. The internal memory provides an environment for the operation of the operating system and the computer program in the non-volatile storage medium. The database of the computer device is configured to store data such as optical signals, electrical signals, first processed signals, and second processed signals. The network interface of the computer device is configured to communicate with an external terminal via a network connection. When the computer program is executed by the processor, a signal processing method for an optical communication receiving end is implemented.

Those skilled in the art will appreciate that the structure shown in FIG. 7 is merely a block diagram of a partial structure related to the embodiment of the present disclosure, and does not constitute a limitation on the computer device to which the embodiment of the present disclosure is applied. The specific computer device may comprise more or fewer components than those shown in the figure, or combine certain components, or have a different arrangement of components.

In one embodiment, a computer device is further provided, including a memory and a processor, wherein a computer program is stored in the memory, and the processor implements the steps in the above method embodiments when executing the computer program.

In one embodiment, a computer-readable storage medium is provided, on which a computer program is stored. When the computer program is executed by a processor, the steps in the above-mentioned method embodiments are implemented.

In one embodiment, a computer program product is provided, including a computer program, which implements the steps in the above method embodiments when executed by a processor.

It should be noted that the user information (including but not limited to user device information, user personal information, etc.) and data (including but not limited to data used for analysis, stored data, displayed data, etc.) involved in the embodiments of the present disclosure are all information and data authorized by the user or fully authorized by all parties.

A person of ordinary skill in the art can understand that all or part of the processes in the above-mentioned embodiment method can be completed by instructing the relevant hardware through a computer program, and the computer program can be stored in a non-volatile computer-readable storage medium. When the computer program is executed, it can comprise the processes of the embodiments of the above-mentioned methods. Among them, any reference to the memory, database or other medium used in each embodiment provided in the embodiments of the present disclosure can comprise at least one of non-volatile and volatile memory. Non-volatile memory can comprise read-only memory (ROM), magnetic tape, floppy disk, flash memory, optical memory, high-density embedded non-volatile memory, resistive random access memory (ReRAM), magnetoresistive random access memory (MRAM), ferroelectric random access memory (FRAM), phase change memory (PCM), graphene memory, etc. Volatile memory can comprise random access memory (RAM) or external cache memory, etc. As an illustration and not limitation, RAM can be in various forms, such as static random access memory (SRAM) or dynamic random access memory (DRAM). The database involved in each embodiment provided in the embodiments of the present disclosure may comprise at least one of a relational database and a non-relational database. Non-relational databases may comprise distributed databases according to blockchains, etc., but are not limited to thereto. The processor involved in each embodiment provided in the embodiments of the present disclosure may be a general-purpose processor, a central processing unit, a graphics processor, a digital signal processor, a programmable logic unit, a data processing logic unit according to quantum computing, etc., but are not limited to thereto.

The technical features of the above embodiments may be arbitrarily combined. To make the description concise, not all possible combinations of the technical features in the above embodiments are described. However, as long as there is no contradiction in the combination of these technical features, they should be considered to be within the scope of this specification.

The above-described embodiments only express several implementation methods of the embodiments of the present disclosure, and the descriptions thereof are relatively specific and detailed, but they cannot be understood as limiting the scope of the patent of the embodiments of the present disclosure. It should be pointed out that, for those of ordinary skill in the art, several variations and improvements can be made without departing from the concept of the embodiments of the present disclosure, and these all belong to the protection scope of the embodiments of the present disclosure. Therefore, the protection scope of the embodiments of the present disclosure shall be subject to the attached claims.

1. A signal processing method at an optical communication receiving end, characterized in that the method comprises:
receiving an optical signal and converting the optical signal into an electrical signal;
performing high-pass filtering on the electrical signal to obtain a first processed signal;
performing filtering processing on the first processed signal by using an adaptive filter, so as to obtain a second processed signal; and
acquiring a difference between the electrical signal and the first processed signal, and adjusting a parameter setting of the adaptive filter according to the difference to change a filtering characteristic of the adaptive filter.

2. The method according to claim 1, characterized in that obtaining a difference between the electrical signal and the first processed signal, and adjusting a parameter setting of the adaptive filter according to the difference to change a filtering characteristic of the adaptive filter comprises:
acquiring a difference between the electrical signal and the first processed signal; and
adjusting the parameter setting of the adaptive filter according to the difference to change the filtering characteristics of the adaptive filter to obtain an adjusted adaptive filter, wherein the adjusted adaptive filter is configured to perform filtering processing on the next first processing signal.

3. The method according to claim 1, characterized in that adjusting the parameter setting of the adaptive filter according to the difference to change the filtering characteristics of the adaptive filter comprises:
determining a target parameter that matches the difference according to a correlation relationship between the difference and the parameters of the adaptive filter; and
adjusting the parameter settings of the adaptive filter according to the target parameters to change the filtering characteristics of the adaptive filter.

4. The method according to claim 3, characterized in that determining a target parameter that matches the difference according to a correlation relationship between the difference and the parameters of the adaptive filter comprises:
acquiring a third processed signal, wherein the third processed signal is obtained by filtering the electrical signal using a low-pass filter, and the third processed signal is positively correlated with the received optical power;
determining a normalized processed signal matching the electrical signal according to the difference and the third processed signal; and
determining a target parameter matching the normalized processed signal according to a correlation relationship between the normalized processed signal and the parameters of the adaptive filter.

5. The method according to claim 1, characterized in that the adaptive filter comprises a digital adaptive filter, and performing filtering processing on the first processed signal by using an adaptive filter, so as to obtain a second processed signal comprises:
performing analog-to-digital conversion on the first processed signal to obtain a first digital processed signal; and
performing filtering processing on the first digital processed signal by using an adaptive filter, so as to obtain a second processed signal.

6. The method according to claim 1 is characterized in that the optical signal is obtained by performing DC balanced encoding and modulation on the original optical signal.

7. The method according to claim 1, characterized in that after obtaining the second processed signal further comprises:
performing signal recovery processing on the second processed signal, so as to obtain a recovered signal.

8. The method according to claim 1, characterized in that receiving an optical signal and converting the optical signal into an electrical signal comprises:
acquiring an optical signal sent by a signal source; and
performing photoelectric conversion on the optical signal to obtain a converted signal, and amplifying the converted signal to obtain an electrical signal.

9. The method according to claim 1, characterized in that the parameters of the adaptive filter comprise a number of taps, and adjusting a parameter setting of the adaptive filter according to the difference to change a filtering characteristic of the adaptive filter comprises:
determining a target number of taps corresponding to the difference value according to a correlation relationship between the difference value and the number of taps of the adaptive filter; and
adjusting the number of taps of the adaptive filter according to the target number of taps to change the filtering characteristics of the adaptive filter.

10. A signal processing system for an optical communication receiving end, characterized in that the system comprises:
a photodetector, for receiving an optical signal and converting the optical signal into an electrical signal;
a high-pass filter, configured to perform high-pass filtering on the electrical signal to obtain a first processed signal; and
an adaptive filter configured to filter the first processed signal to obtain a second processed signal, wherein parameters of the adaptive filter are adjusted according to the difference between the electrical signal received by the photodetector and the corresponding first processed signal.

11. The system according to claim 10, characterized in that the adaptive filter comprises:
an adaptive filter configured to filter the first processed signal to obtain a second processed signal, wherein parameters of the adaptive filter are adjusted according to the difference between a previous electrical signal and a corresponding first processed signal.

12. The system according to claim 10, characterized in that the system further comprises:
an analog-to-digital converter, configured to perform analog-to-digital conversion on the first processed signal to obtain a first digital processed signal;
the adaptive filter comprising:
a digital adaptive filter, configured to filter the first digital processed signal to obtain a second processed signal, wherein parameters of the adaptive filter are adjusted according to the difference between the electrical signal received by the photodetector and a corresponding first processed signal.
